(19) United States
(12) Patent Application Publication
(10) Pub. No.: US 2020/0331318 A1
(43) Pub. Date: Oct. 22, 2020

(54) MOTOR VEHICLE HEATING SYSTEM AND MOTOR VEHICLE

(71) Applicant: Faurecia Emissions Control Technologies, Germany GmbH, Augsburg (DE)

(72) Inventors: Christopher BEAUCHAMP, Augsburg (DE); Hans-Christoph HOSSFELD, Augsburg (DE)

(21) Appl. No.: 16/846,567

(22) Filed: Apr. 13, 2020

(30) Foreign Application Priority Data
Apr. 17, 2019 (DE) 10 2019 110 139.5

(51) Int. Cl. B60H 1/00; F28D 20/00; B60H 1/02

(52) U.S. Cl. CPC B60H 1/00499; B60H 1/025; F28D 20/003

(57) ABSTRACT

A motor vehicle heating system includes an internal combustion engine, an exhaust system, a coolant circuit, and a heat storage system that is connected to the exhaust system via at least one heat storage device. The heat storage system is adapted to be coupled to the coolant circuit such that heat can be transferred between the heat storage system and the coolant circuit. The heat storage system includes a thermochemical storage material. Furthermore, a motor vehicle having such a heating system is provided.

### CROSS REFERENCE TO RELATED APPLICATIONS

This application is a U.S. non-provisional application claiming the benefit of German Application No. 10 2019 110 139.5, filed on Apr. 17, 2020, which is incorporated herein by its entirety.

### TECHNICAL FIELD

The disclosure relates to a motor vehicle heating system and to a motor vehicle.

### BACKGROUND

In motor vehicles having internal combustion engines, exhaust heat from the internal combustion engine can be used to heat a coolant circulating in a coolant circuit. The coolant serves to cool the internal combustion engine. At the same time, the coolant can be used to heat a passenger compartment. For this purpose, the coolant must have a certain minimum temperature. In order to reach this minimum temperature as quickly as possible, motor vehicles usually include an exhaust heat recovery system by which heat can be removed from an exhaust system to heat the coolant. However, after a cold start of the internal combustion engine, the exhaust system is not at a sufficient temperature to heat the coolant. Therefore, after a cold start of the internal combustion engine, electrical consumers such as PTC heating elements are switched on to heat a passenger compartment more quickly. However, these measures result in an increased consumption of electrical energy, which reduces an electrical travelling range of hybrid vehicles, for example.

In order to reduce a consumption of electrical energy, it is known to provide heat storage systems. However, these do not have a satisfactory storage density and/or can store thermal energy only for a short period of time.

### SUMMARY

A motor vehicle heating system is provided that comprises an internal combustion engine, an exhaust system, a coolant circuit and a heat storage system which is connected to the exhaust system via at least one heat storage device. The heat storage system is adapted to be coupled to the coolant circuit such that heat can be transferred between the heat storage system and the coolant circuit. The heat storage system includes a thermochemical storage material.

Thermochemical storage materials have the advantage over other heat storage materials in that they have a particularly long storage period and a high storage density. In particular, thermochemical storage materials have an unlimited storage period. This means that heat storage systems including a thermochemical storage material do not discharge automatically. A storage density of thermochemical storage materials is between 500 kJ/kg and 3000 kJ/kg, in particular between 1000 kJ/kg and 3000 kJ/kg.

The heating device is particularly suitable for conventional motor vehicles and for hybrid vehicles, in particular for so-called full hybrid vehicles, plug-in hybrid vehicles and mild hybrid vehicles.

According to one embodiment, the thermochemical storage material may be selected from the group of carbonates, hydrides, hydrates, hydroxides and/or ammonia compounds. These materials have a high temperature resistance and are available at low cost.

In particular, the thermochemical storage material may comprise iron carbonate and/or potassium carbonate and/or aluminum hydride and/or magnesium bromide and/or calcium hydroxide and/or magnesium hydroxide, or may consist of one of these materials. These materials are particularly suitable for heat storage.

The heat storage system preferably has a working medium, in particular water. Water is particularly cost-effective. Alternatively, the working medium may be selected from the same family of materials as the thermochemical storage material. For example, the working medium contains hydrogen, ammonia or carbon dioxide. When the working medium reacts with, in particular is absorbed by the thermochemical storage material, heat is released, i.e. an exothermic reaction takes place. The reaction is in particular reversible. The working medium may be in a solid, liquid or gaseous state.

The heat storage system may comprise a first chamber and a second chamber which are fluidically connected to each other so that the working medium can flow from the second chamber to the first chamber and vice versa. In this way, heat can be released and stored by reacting the working medium with or by separating it from the thermochemical storage material.

A valve which is suitable for selectively closing or opening a flow path between the chambers is arranged between the chambers. A reaction between the thermochemical storage material and the working medium can thus be prevented or enabled. It is therefore possible to control a chemical reaction in the heat storage system.

According to one embodiment, both chambers are connected to the exhaust system via one respective heat exchanger. In this way, the exhaust gas heat can be used, on the one hand, to activate the heat storage system, as a result of which the heat storage system can release heat to the coolant circuit, i.e. to a coolant circulating in the coolant circuit. Furthermore, the exhaust heat can be used to charge the heat storage system.

For example, the first chamber and/or the second chamber are each arranged in a separate, preferably switchable bypass channel of the exhaust system. This has the advantage that it is possible to control whether exhaust heat can be supplied to the chambers via the heat exchanger or not. The bypass channels are in particular adapted to be switched independently of each other. Therefore, by switching a bypass channel, the heat storage system can be brought into an activated state, in which heat can be released to the coolant circuit, or into a charging state, in which heat is stored in the heat storage system.

According to one embodiment, the first chamber contains the thermochemical storage material, and the first chamber is arranged upstream of the second chamber in the direction of an exhaust gas flow. The exothermic reaction by which the coolant can be heated takes place in the chamber containing the thermochemical storage material, when the working medium is supplied to the first chamber. The arrangement of the first chamber upstream of the second chamber is advantageous, on the one hand, in terms of installation space, as the upstream chamber is located closer to the internal combustion engine and the coolant circuit may thus be configured smaller. A further advantage is that the exhaust gas flowing through the exhaust system has a higher temperature at a position further upstream than at a position further downstream. The heat storage system can thus be charged more efficiently if the first chamber, to which heat must be supplied when charging the system, is located further upstream.

Preferably, the coolant circuit comprises a heat exchanger which directly couples the coolant circuit thermally to the exhaust system. The coolant circulating in the coolant circuit can thus be heated by exhaust heat as an alternative or in addition to the heat storage system. The motor vehicle heating system can thus be particularly efficient. When the exhaust gas flowing through the exhaust system is hot enough, the coolant can be heated and/or the heat storage system can be charged if the coolant is already at a sufficiently high temperature.

The heat exchanger of the coolant circuit may be arranged between the chambers in terms of flow, in particular in a separate, preferably switchable bypass channel.

Movable flaps which are adapted to close or open a flow path through the bypass channel are for example provided for switching the bypass channels on and off.

Furthermore, the disclosure relates to a vehicle having a motor vehicle heating system according to the disclosure.

### BRIEF DESCRIPTION OF THE DRAWINGS

FIG. 1 shows a motor vehicle heating system according to the disclosure of a motor vehicle according to the disclosure in a first operating state,

FIG. 2 shows a temperature profile of the coolant in the motor vehicle heating system,

FIG. 3 shows the motor vehicle heating system from FIG. 1 in a second operating state,

FIGS. 4 and 5 show the temperature profile of the coolant in the motor vehicle heating system,

FIG. 6 shows the motor vehicle heating system from FIG. 1 in a further operating state, and

FIG. 7 shows the temperature profile of the coolant in the motor vehicle heating system.

### DETAILED DESCRIPTION

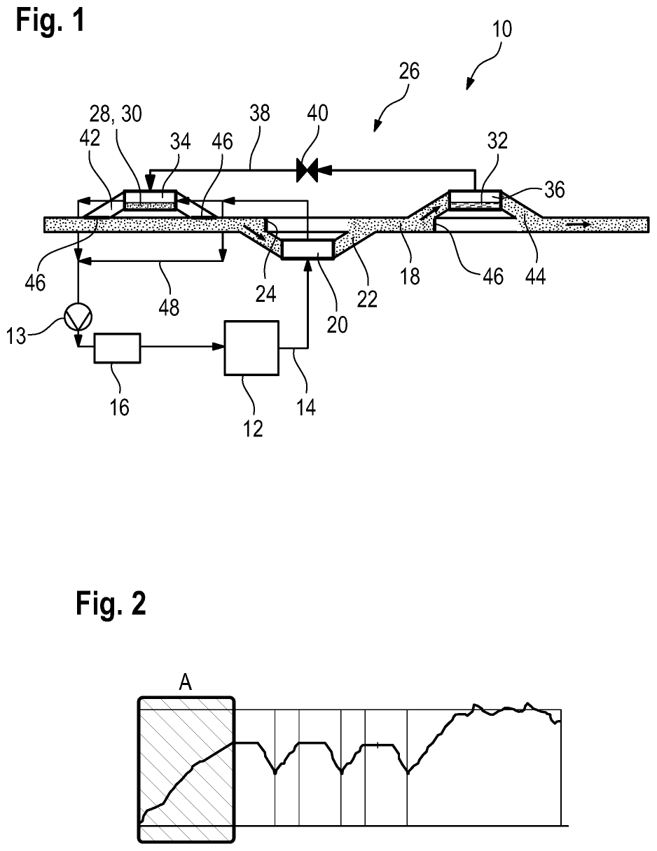

FIG. 1 shows a motor vehicle heating system 10 according to the disclosure of a motor vehicle. The motor vehicle heating system 10 comprises an internal combustion engine 12 and a coolant circuit 14, wherein a coolant circulating through the coolant circuit 14 is suitable for cooling the internal combustion engine 12 during operation. The coolant is then heated, the absorbed heat being in turn adapted to be used to heat a vehicle interior with an interior heater 16. The motor vehicle heating system furthermore includes a pump 13 to permit a circulation of the coolant.

In addition, the motor vehicle heating system 10 comprises an exhaust system 18 and optionally a heat exchanger 20, which directly couples the coolant circuit 14 thermally to the exhaust system 18. It is thus possible to additionally supply waste heat from the exhaust gas flowing through the exhaust system 18 to the coolant in order to heat up the vehicle interior as quickly as possible.

The heat exchanger 20 is arranged in a separate, switchable bypass channel 22 so that the heat exchanger 20 can be deactivated as soon as the coolant has heated up to a sufficiently high temperature.

To deactivate the heat exchanger 20, a flap 24 is provided which is adapted to close a flow path through the bypass channel 22 so that no exhaust gas can flow through the heat exchanger 20.

However, according to one embodiment which is not shown, the heat exchanger 20 may also be dispensed with.

After a cold start of the motor vehicle, when the internal combustion engine 12 and the exhaust gas flowing through the exhaust system 18 do not yet have a sufficiently high temperature, it took a certain amount of time to heat the coolant in the coolant circuit 14 to such an extent that a vehicle interior can be heated efficiently.

In order to reduce this period of time and to heat the vehicle interior as quickly as possible, the motor vehicle heating system 10 also includes a heat storage system 26 which is connected to the exhaust system 18 via a heat storage device 28 and which is adapted to be coupled to the coolant circuit such that heat can be transferred between the heat storage system 26 and the coolant circuit 14. The heat storage system can basically be coupled to the coolant circuit 14 at any point in the coolant circuit 14.

In order to be able to release and also store heat again, the heat storage system 26 has a thermochemical storage material 30. The thermochemical storage material 30 is for example selected from the group of carbonates, hydrides, hydrates, hydroxides and/or ammonia compounds. The thermochemical storage material 30 for example comprises iron carbonate and/or potassium carbonate and/or aluminum hydride and/or magnesium bromide and/or MgCl₂+NH₃ and/or calcium hydroxide and/or magnesium hydroxide or consists of one of these materials.

Furthermore, the heat storage system 26 additionally has a working medium 32. The working medium 32 may be absorbed by the thermochemical storage material 30. An exothermic chemical reaction takes place, i.e. heat is released during the reaction. This heat is used to heat the coolant in the coolant circuit 14. To recharge the heat storage system 26, i.e. to store heat, heat must be supplied to the thermochemical storage material 30 with the working medium 32 absorbed therein. When recharging the heat storage system 26, the supplied heat must be above an activation temperature.

The heat storage device 28 in particular contains the thermochemical storage material 30 and the working medium 32.

The heat storage system 26 further comprises a first chamber 34 and a second chamber 36 which are fluidically connected to each other, for example via a line 38. The first chamber 34 is arranged upstream of the second chamber 36.

If the coolant circuit 14 comprises a heat exchanger 20, as shown in the figures, the heat exchanger 20 is preferably arranged between the chambers 34, 36 in terms of flow.

The chambers 34, 36 contain the working medium 32, and the chamber 34 contains the thermochemical storage material 30.

The working medium 32 can flow from the second chamber 36 to the first chamber 34 and vice versa via the line 38.

The thermochemical storage material 30 is in particular a solid material which is permanently arranged in the first chamber 34. The working medium 32 can however be in a solid, liquid and/or gaseous state.

In order to regulate a supply of the working medium 32 to the first chamber 34 and thus to control the absorption reaction in the first chamber 34, a valve 40 is arranged between the two chambers 34, 36, in particular in the line 38. The valve 40 is suitable for either closing or opening a flow path between the chambers. It is also possible to vary a flow cross-section of the line 38 by using the valve 40, so that the quantity of working medium 32 which can flow to the first chamber 34 can be regulated.

Both chambers 34, 36 are each connected to the exhaust system 18 via a heat exchanger not shown in the figures for the sake of simplicity. This makes it possible to supply heat to the chambers 34, 36 in order to activate or charge the heat storage system 26.

Both the first chamber 34 and the second chamber 36 are each arranged in a separate bypass channel 42, 44 of the exhaust system 18. The bypass channels 42, 44 can be switched to the exhaust system 18 such that exhaust gas can flow through the bypass channels 42, 44. In order to prevent an exhaust gas flow through the bypass channels 42, 44, a movable flap 46 is arranged in each of the bypass channels 42, 44, which is suitable for closing the respective bypass channel 42, 44.

In order to charge the heat storage system 26, in particular the heat storage device 28, a higher temperature is necessary than for activating the heat storage system 26 and for causing an exothermic reaction. This is useful in that an activation of the heat storage system 26 should already be possible at a low exhaust gas temperature when additional heat energy is required.

An exothermic reaction takes place in particular according to the following reaction scheme:

A+B→AB+E

If the thermochemical storage material 30 contains potassium carbonate and the working medium 32 is water, an exothermic reaction can take place as follows:

K₂CO₃+1.5H₂O→K₂CO₃*1.5H₂O+E

If the thermochemical storage material 30 contains magnesium hydroxide and the working medium 32 is water, an exothermic reaction can take place as follows:

MgO+H₂O→Mg(OH)₂+E

In both reactions, water is absorbed in the thermochemical storage material 30, thus releasing energy.

In both cases, the thermochemical storage material 30 is in a solid state.

For the sake of simplicity, not all possible reactions with all possible storage materials are listed. However, the reactions basically follow the same pattern.

If the coolant in the coolant circuit 14 is sufficiently heated, the heat storage system 26 can be decoupled from the coolant circuit 14. To this end, the coolant circuit 14 has a bypass channel 48 which bypasses the heat storage system 26, in particular the first chamber 34.

In the following, various operating states of the motor vehicle heating system 10 are explained on the basis of FIGS. 1 to 6.

FIG. 1 illustrates a first operating state in which the heat storage system 26 is at least partially charged and in which the heat storage system 26 is active.

FIG. 1 in particular illustrates a state after a cold start of the motor vehicle or another phase in which the coolant in the coolant circuit 14 is to be heated via the heat storage system 26.

While the internal combustion engine 12 is running, heat from the exhaust system 18 is on the one hand transferred into the coolant circuit 14 via the heat exchanger 20. However, this is optional.

The exhaust gas flowing through the exhaust system 18 also heats the working medium 32 in the second chamber 36. To make this possible, the bypass channel 44 is switched to the exhaust system 18, and an exhaust gas flow through the bypass channel 44 is possible. Heat from the exhaust gas can be transferred into the second chamber 36 via the heat exchanger which is not shown.

The first chamber 34, on the other hand, is decoupled from the exhaust system 18, but coupled to the coolant circuit 14 via a heat exchanger which is not shown.

In order to activate the heat storage system 26, the working medium 32 must be heated at least up to its activation temperature. If water is used as a working medium 32, the exhaust gas should have a temperature of 100° C. or more.

By heating the working medium 32, at least part of the working medium 32 is evaporated. In a vaporous state, the working medium 32 can flow through the line 38 to the first chamber 34. The valve 40 is then open.

The movement of the working medium 32 into the first chamber 34 is promoted by the increasing pressure in the second chamber 36. For example, there may be a temporary overpressure in the second chamber 36.

An exothermic reaction can then take place in the first chamber 34, for example one of the reactions described above.

FIG. 2 illustrates a temperature profile of the coolant in the motor vehicle heating system 10. The temperature profile corresponding to the operating state illustrated in FIG. 1 is framed in FIG. 2 (area A). Area A illustrates that the coolant is continuously heated after a cold start, more specifically by the waste heat from the internal combustion engine 12, the heat exchanger 20 and/or the heat storage system 26.

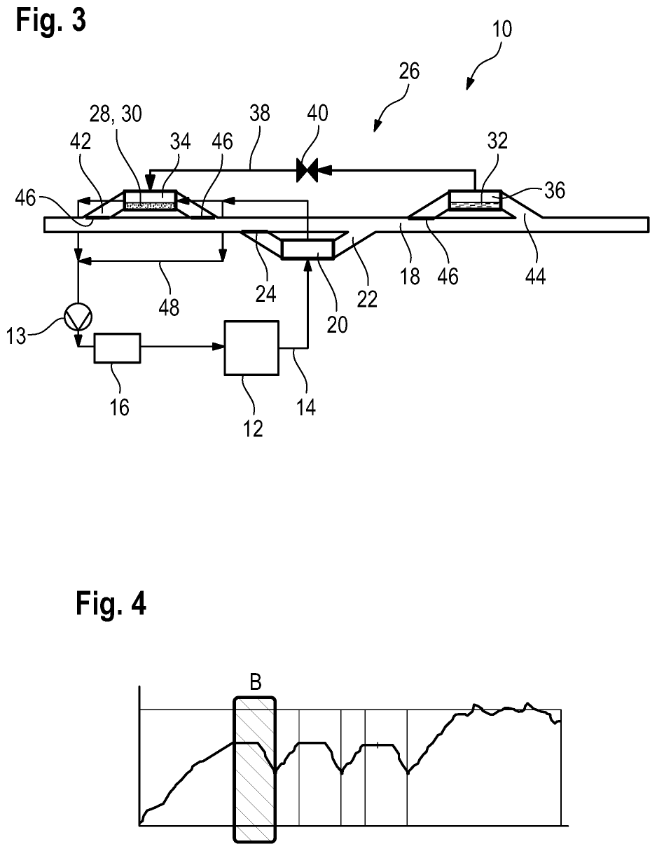

FIG. 3 illustrates an operating state in case of a purely electric style of driving that follows the first operating state.

The internal combustion engine 12 is not active in this operating state. The bypass channels 22, 42, 44 are decoupled from the exhaust system 18 in this state.

However, there is still residual heat in the heat exchanger 20 and in the second chamber 36, as the internal combustion engine 12 was active immediately therebefore.

As long as the residual heat in the second chamber 36 is still sufficient to activate the heat storage system 26, heat can still be transferred from the heat storage system 26 to the coolant circuit 14. This means that the residual heat in the second chamber 36 must still be high enough to evaporate part of the working medium 32. The exothermic reaction can continue to take place in the first chamber 34 as long as this is the case.

Residual heat can still be transferred to the coolant via the heat exchanger 20.

FIG. 4 again shows the temperature profile from FIG. 2. Area B is however framed in FIG. 4, which illustrates the second operating state in case of a purely electrical style of driving. As long as the heat exchanger 20 and/or the heat storage system 26 still release heat to the coolant, the temperature of the coolant remains largely constant, as illustrated in area B in FIG. 4.

However, if the residual heat in heat exchanger 20 and in the second chamber 36 drops too far, heat can no longer be transferred to the coolant in a purely electrical style of driving, and the temperature of the coolant drops, as also shown in section B in FIG. 4.

The heat storage system 26 is discharged during the first and the second operating state.

The operating states illustrated in FIG. 1 and FIG. 3 may be repeated several times. This is apparent from the temperature profile shown in FIGS. 2 and 4.

In particular, the second operating state may be followed by an operating state in which the internal combustion engine 12 is reactivated, for example due to increased torque requirements or because an electrical energy storage device is discharged.

If the heat storage system 26 is not yet discharged, energy can again be transferred from the heat storage system 26 to the coolant, more specifically in the same way as described in FIG. 1.

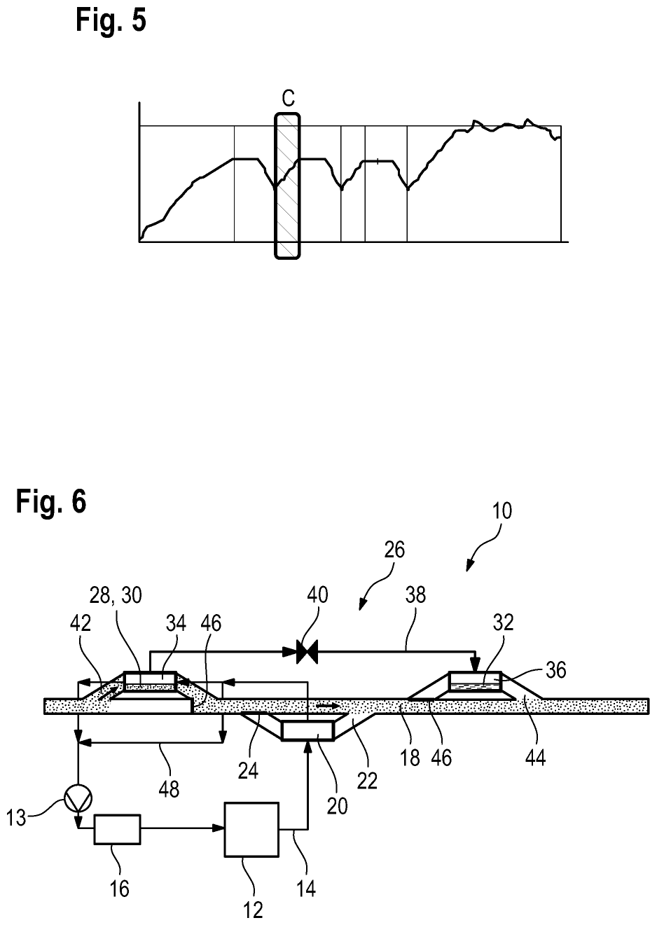

This state is illustrated in FIG. 5, which again shows the temperature profile from FIG. 2. However, area C is framed in FIG. 5, which illustrates a further operating state in case of a style of driving with an internal combustion engine. The temperature of the coolant rises again in this phase.

The operating states described can be repeated, for example, until the heat storage system 26 is completely discharged or until additional heat release by the heat storage system 26 is no longer necessary.

FIG. 6 illustrates an operating state in which the heat storage system 26 is charged.

In this operating state, no heat is transferred from the heat storage system 26 to the coolant circuit 14. Therefore, the heat storage system 26 is decoupled from the coolant circuit 14 in this operating state, in particular by passing the coolant through the bypass channel 48 rather than through the heat storage system 26.

The internal combustion engine 12 is active in this state, and the coolant is already at a high temperature.

Since an additional heat supply to the coolant via the heat exchanger 20 or the heat storage system 26 is not necessary in this operating state, the bypass channel 22 under the bypass channel 44, which contain the heat storage device 20 and the second chamber 36, respectively, are decoupled from the exhaust system 18. Alternatively, it is conceivable that the bypass channel 22 is switched so that heat can still be transferred via the heat exchanger 20 into the coolant circuit 14.

The bypass channel 42, in which the first chamber 34 is located, is however switched to the exhaust system 18. Consequently, heat is supplied to the first chamber 34.

By supplying heat, an endothermic reaction can take place in the first chamber 34, in which the previously absorbed working medium 32 is released again.

An endothermic reaction takes place in particular according to the following reaction scheme:

AB+E→A+B

In particular, the reverse reactions to the exothermic reactions mentioned above take place. These are inserted below:

K₂CO₃*1.5H₂O+E→K₂CO₃+1.5H₂O

Mg(OH)₂+E→MgO+H₂O

The working medium 32 liberated during the endothermic reactions, in the examples given water or steam, can flow back into the second chamber 36 via the line 38 when the valve 40 is open, and can condense there.

When the heat storage system 26 is completely charged and the coolant still has a sufficiently high temperature, in particular when the internal combustion engine 12 is still active, the heat storage system 26 can be deactivated. This is carried out in that the valve 40 is closed and the bypass channel 42 is decoupled from the exhaust system 18.

Afterwards, the previously described operating states can run again.

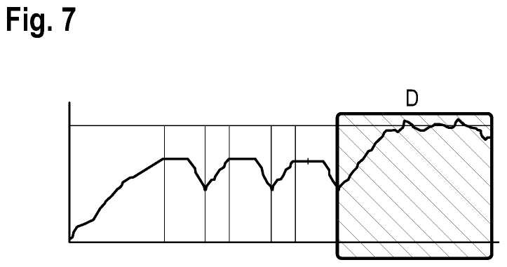

FIG. 7 again shows the temperature profile from FIG. 2. However, area D is framed in FIG. 7, which illustrates the operating state during charging of the heat storage system.

Although various embodiments have been disclosed, a worker of ordinary skill in this art would recognize that certain modifications would come within the scope of this disclosure. For that reason, the following claims should be studied to determine the true scope and content of this disclosure.

1. A motor vehicle heating system, comprising:
an internal combustion engine; an exhaust system; a coolant circuit; and
a heat storage system which is connected to the exhaust system via at least one heat storage device and which is adapted to be coupled to the coolant circuit such that heat can be transferred between the heat storage system and the coolant circuit, the heat storage system including a thermochemical storage material.

2. The motor vehicle heating system according to claim 1, wherein the thermochemical storage material is selected from the group of carbonates, hydrides, hydrates, hydroxides and/or ammonia compounds.

3. The motor vehicle heating system according to claim 1, wherein the thermochemical storage material comprises iron carbonate and/or potassium carbonate and/or aluminium hydride and/or magnesium bromide and/or calcium hydroxide and/or magnesium hydroxide.

4. The motor vehicle heating system according to claim 1, wherein the heat storage system includes a working medium.

5. The motor vehicle heating system according to claim 4, wherein the heat storage system comprises a first chamber and a second chamber which are fluidically connected to each other, such that the working medium can flow from the second chamber to the first chamber and vice versa.

6. The motor vehicle heating system according to claim 5, wherein a valve which is suitable for selectively closing or opening a flow path between the first and second chambers is arranged between the first and second chambers.

7. The motor vehicle heating system according to claim 5, wherein both the first and chambers are connected to the exhaust system via a respective heat exchanger.

8. The motor vehicle heating system according to claim 5, wherein the first chamber and/or the second chamber is/are arranged in a respective separate bypass channel of the exhaust system.

9. The motor vehicle heating system according to claim 5, wherein the first chamber includes the thermochemical storage material and in that the first chamber is arranged upstream of the second chamber in the direction of an exhaust gas flow.

10. The motor vehicle heating system according to claim 1, wherein the coolant circuit comprises a heat exchanger which directly couples the coolant circuit thermally to the exhaust system.

11. The motor vehicle heating system according to claim 5, wherein that the coolant circuit comprises a heat exchanger which directly couples the coolant circuit thermally to the exhaust system, the heat exchanger of the cooling circuit being arranged in terms of flow between the first and second chambers in a bypass channel.

12. The motor vehicle heating system according to claim 11, wherein the bypass channel is a separate, switchable bypass channel.

13. A motor vehicle comprising a motor vehicle heating system according to claim 1.

14. The motor vehicle heating system according to claim 5, wherein the separate bypass channel comprises a switchable bypass channel.
